(19) United States
(12) Patent Application Publication
(10) Pub. No.: US 2004/0066145 A1
(43) Pub. Date: Apr. 8, 2004

(54) Programmable electronic unit mounted into a case, allowing to light or making flash varied luminous element connected independently inside the case and letters, so as to give a desired visual effect according a predetermined sequence

(76) Inventor: Denis Simard, Quebec (CA)

Correspondence Address: Mr. Denis Simard, 3815 rue des Opales, Levis, QC, G6W 7M3, CA

(21) Appl. No.: 10/263,317

(22) Filed: Oct. 3, 2002

(51) Int. Cl. H01J 1/60

(52) U.S. Cl. 315/130; 315/291

(57) ABSTRACT

The present invention is a programmable electronic unit mounted into a case, allowing to light or making flash varied luminous element connected independently by means of ballast inside the case and letters, so as to give a desired visual effect according a predetermined sequence.

### BACKGROUND OF THE INVENTION

1. Field of the Invention

The present invention relates to a programmable electronic unit mounted into a case, allowing to light or making flash varied luminous element connected independently by means of ballast inside the case and letters, so as to give a desired visual effect according a predetermined sequence.

2. Description of the Related Art

A search of prior art records has unveiled the following patents:

1. CA 567,675 issued in 1958 to Scott;

2. U.S. Pat. No. 5,504,144 issued in 1996 to Dorpfeld;

3. CA 2,281,127 registered in 1999 to Pietrinferno; and

4. U.S. Pat. No. 4,629,946 issued in 1986 to Amano.

As can be seen the patents mentioned above are probably the most relevant.

The proposed system is a programmable electronic unit mounted into a case, allowing to light or making flash varied luminous element connected independently by means of ballast inside the case and letters, so as to give a desired visual effect according a predetermined sequence varying from one to fifty second.

### SUMMARY OF THE INVENTION

It has been discovered that the present invention described herein allows by means of one or many programmable electronic unit and electronic relays to light or making flash varied luminous element connected independently by means of ballast inside the case and letters, so as to give a desired visual effect according a predetermined sequence varying from one to fifty second.

The data coming from a computer are transmitted to programmable electronic unit which transmitting the pulses in sequence to electronic relays which transmitting the signal to varied luminous element mounted inside the case and letters according a predetermined sequence varying from one to fifty second depending of the desired visual effect.

### BRIEF DESCRIPTION OF THE SEVERAL VIEWS OF THE DRAWING(S)

FIG. 1 is a perspective view of a case comprising the raised channel letters, a case having a front part wide open including the jagged letters provided with a top which fitting into each letter, the neon light are mounted inside the case and channel letters, a programmable electronic unit, the sliding hinges, the electronic relays and ballast.

FIG. 2 is a front view of the FIG. 1 showing the channel letters without their top.

FIG. 3a is a perspective view of case having its front part closed and showing the raised channel letters including their top.

FIG. 3b is a perspective view of case having its front part closed and showing the raised channel letters without their top.

FIG. 3c is a perspective view of case having its front part closed and and moved forward by the sliding hinges, and showing the raised channel letters without their top.

FIG. 3d is a a perspective view of case having its front part open and moved forward by the sliding hinges, and showing the raised channel letters without their top.

FIG. 4 is an exploded view of the FIG. 1.

FIG. 5 is a perspective view of a case comprising the channel letters flush to case, a translucent front part open without the jagged letters, the neon lights mounted inside the case and each channel letter, the ballast, the electronic relays, the programmable elctronic unit and the sliding hinges.

FIG. 6a is a perspective view of the FIG. 5 with the front part closed.

FIG. 6b is a a perspective view of the FIG. 5 with the front part open.

FIG. 7 is a perspective view of a case comprising an opaque front part including the jagged letters, the separators mounted between each letter, the neon lights mounted behind each letter, the electronic relays, the programmable electronic unit, and the conventional hinges.

FIG. 8a is a perspective view of the FIG. 7 with the front part closed.

FIG. 8b is a perspective view of the FIG. 7 with the front part open.

FIG. 9a is a perspective view of a sliding hinge in closed position.

FIG. 9b is a perspective view of a sliding hinge in open position with its raised end.

FIG. 9c is a perspective view of a sliding hinge in open position with its lowered end.

FIG. 10 is a perspective view of a structural arm member which is mounted inside each channel letter holding in position each neon light

FIG. 11 is a section view of the FIG. 3a.

### DETAILED DESCRIPTION OF THE INVENTION

Referring to the drawings in more detail, it may be seen that the present invention allows to light or making flash varied luminous element connected independently inside the case and letters, so as to give a desired visual effect according a predetermined sequence.

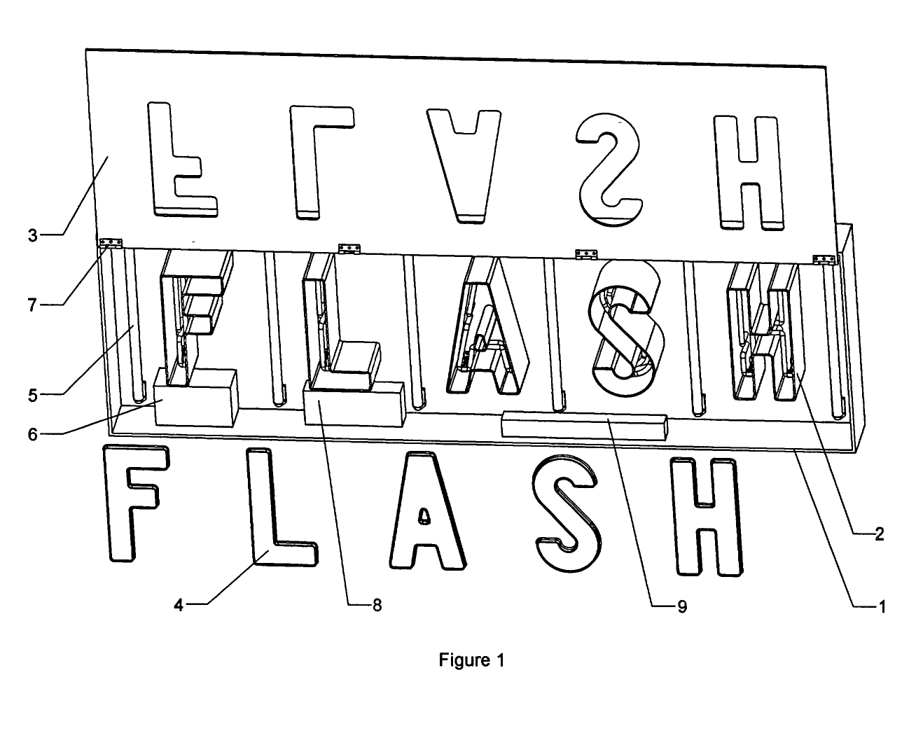

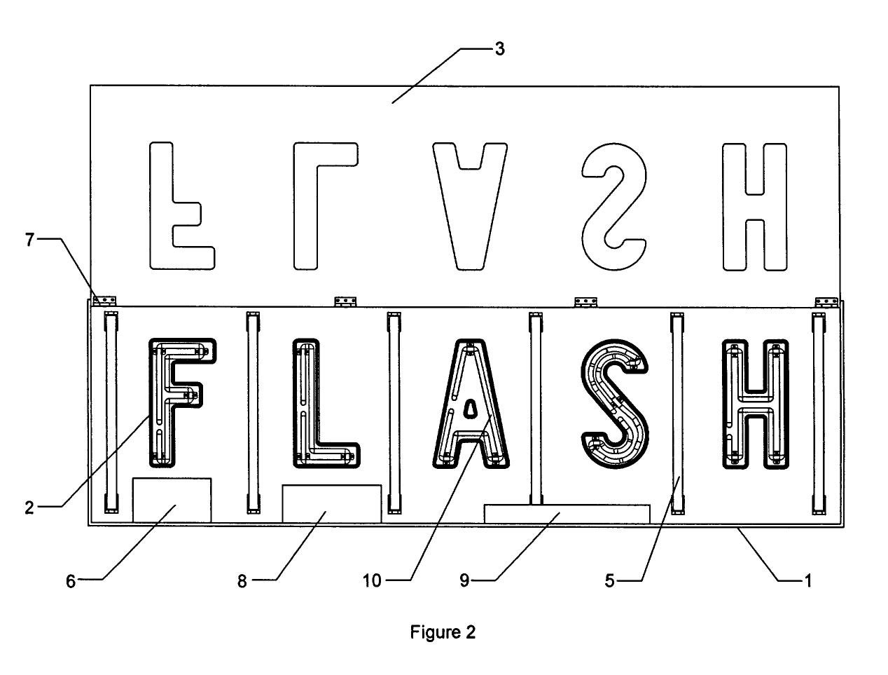

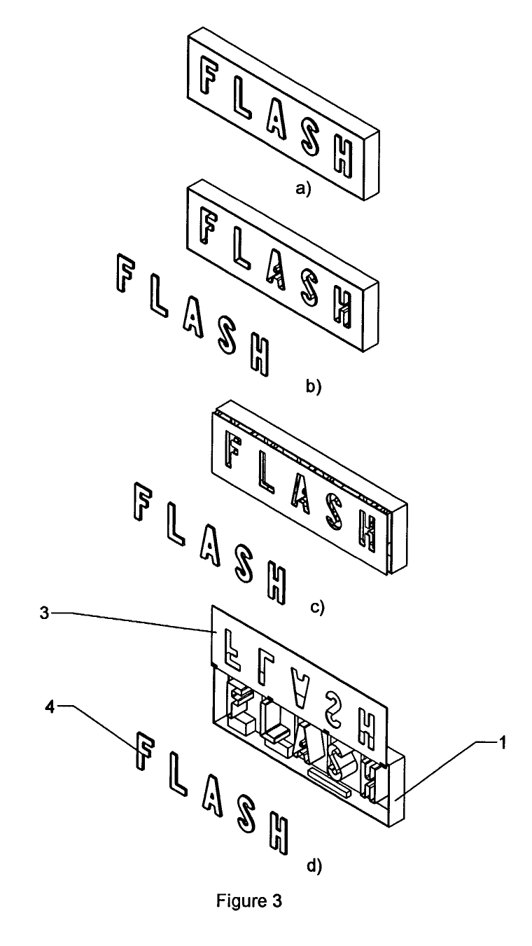

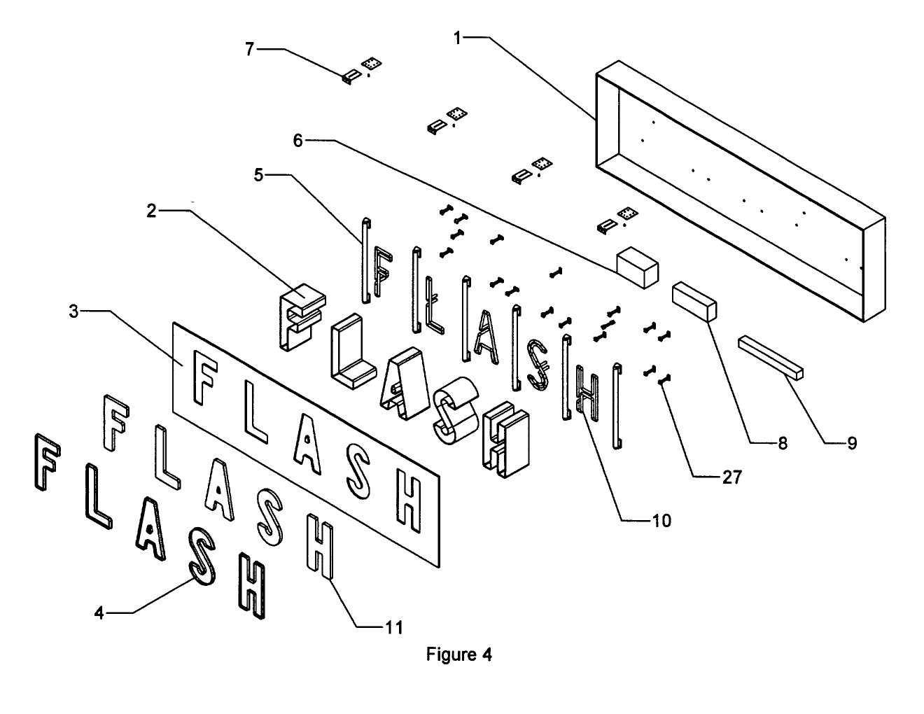

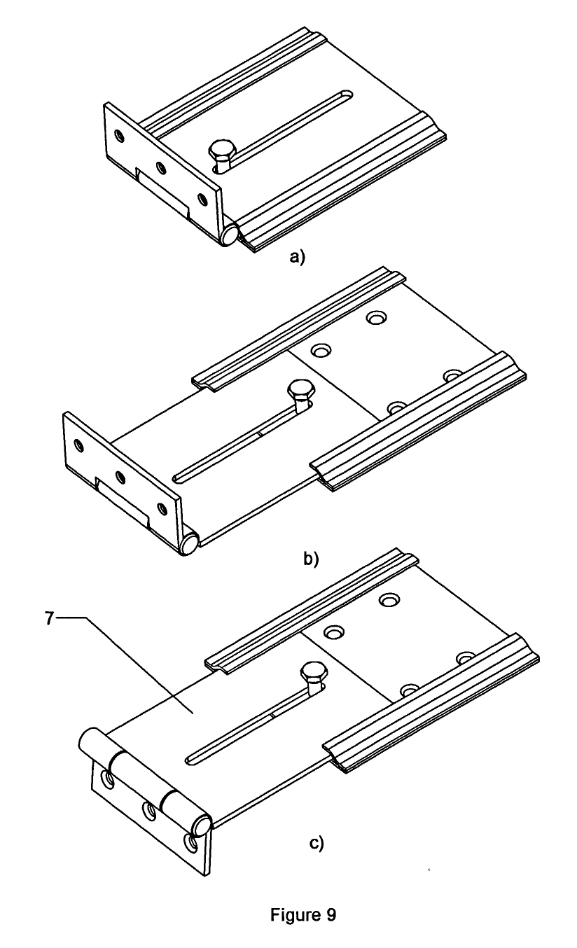

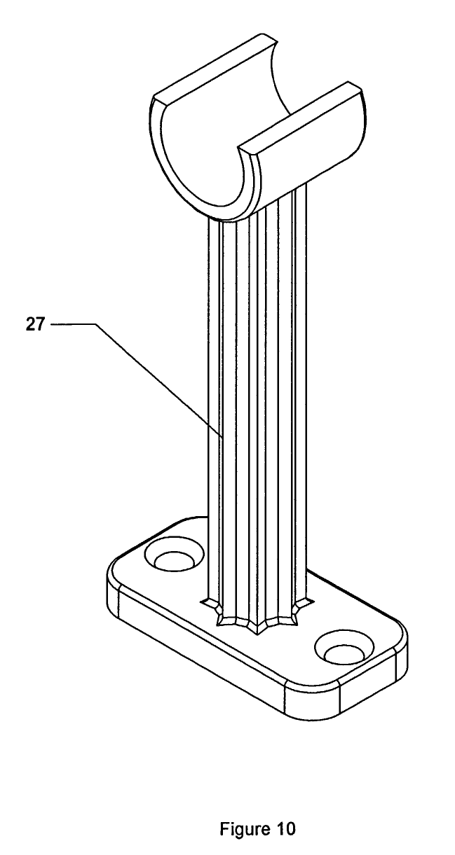

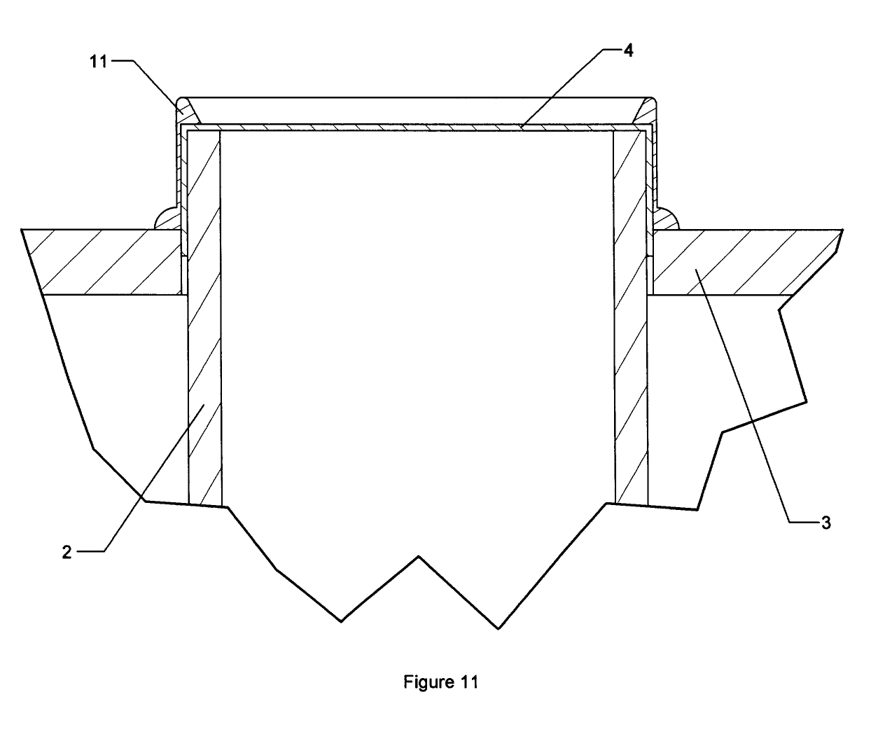

As shown in FIGS. 1, 2, 3, 4, 9, 10 and 11, the data coming from a computer are transmitted to the programmable electronic unit (6) transmitting the pulses in sequence to the electronic relays (8), which transmitting the signal to varied luminous element connected by means of ballast (9) inside the case (1) and channel letters (2) provided with a top (4) according a predetermined sequence varying from one to fifty second depending of the desired visual effect.

A case (1) having a translucent or opaque front part (3) includes the jagged letters allowing to raised channels letters (2) passing through of the front part (3).

The neon lights (5) mounted inside the case (1) allow to light the case (1), and the neon lights (10) mounted inside of channel letters (2) allow to light or making flash the channel letters (2) provided with a rubber trim (11) avoiding the reflection of luminous element onto the case (1).

The hinges (7) having a fixed and sliding part are mounted to the case (1) and to the front part (3), which allow to move forward or to lift up before to lower the front part (3) to free the raised channel letters (2) in order to to modify if desired the program of electronic unit (6), and make the reparation and maintenance.

The structural arm members (27) are mounted inside the channel letters (2) keeping the neon lights (10) in position, and make easier the installation and maintenance of these ones.

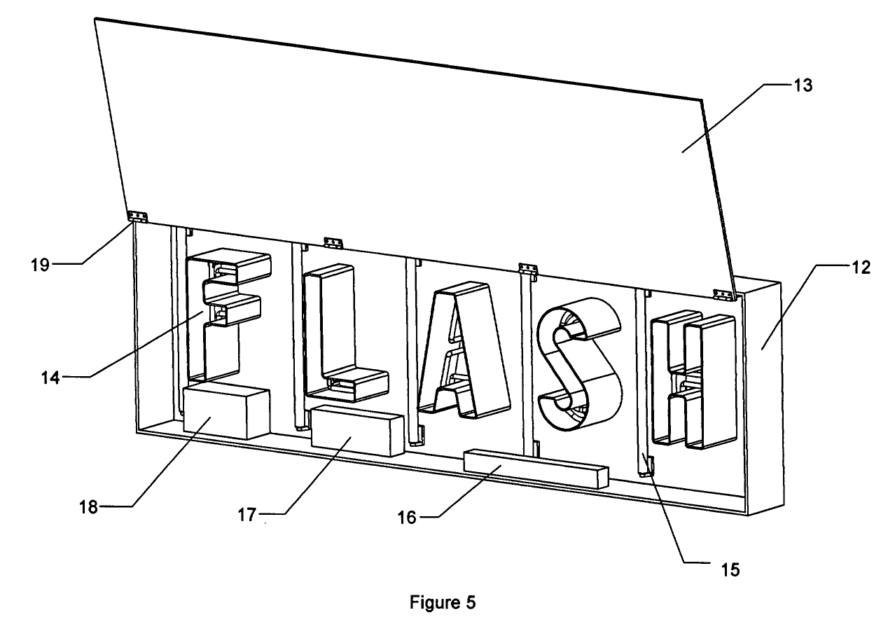

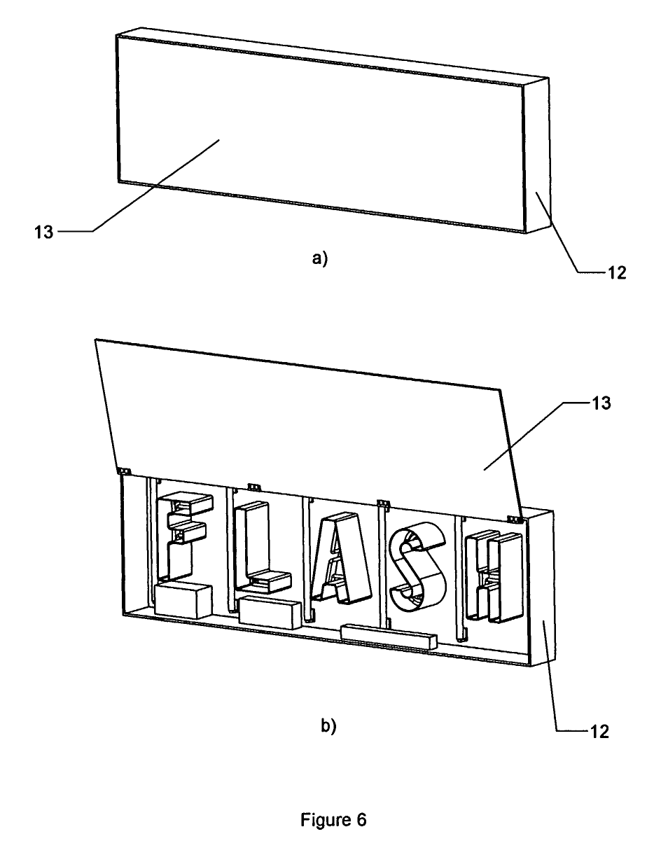

As shown in FIGS. 5 to 6, the data coming from a computer are transmitted to the programmable electronic unit (18) transmitting the pulses in sequence to the electronic relays (17), which transmitting the signal to varied luminous element connected by means of ballast (16) inside the case (12) and channel letters (14) according a predetermined sequence varying from one to fifty second depending of the desired visual effect.

A case (12) having a plain translucent front part (13) is mounted to the case (12) by the conventional hinges (19), which allow to lift up or lower the front part (13) in order to modify if desired the program of electronic unit (18), and make easier the reparation and maintenance.

The neon lights (15) connected inside the case (12) by the ballast (16) allow to light this one, and the neon lights (10) mounted inside of channel letters (14) flush to case (12), allow to light or making flash these ones.

The structural arm members (27) are mounted inside the channel letters (14) keeping the neon lights (10) in position, and make easier the installation and maintenance of these ones.

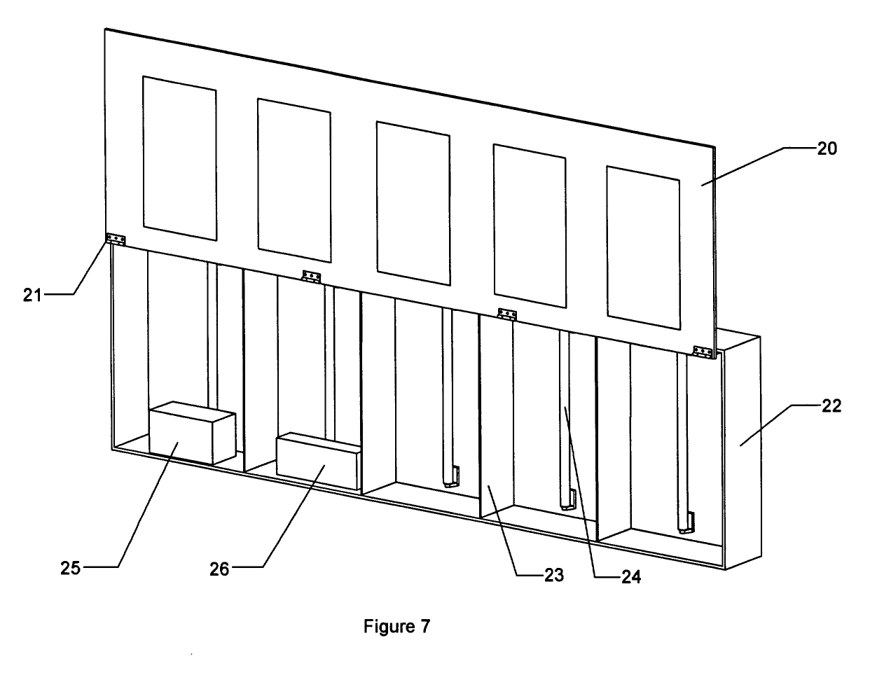

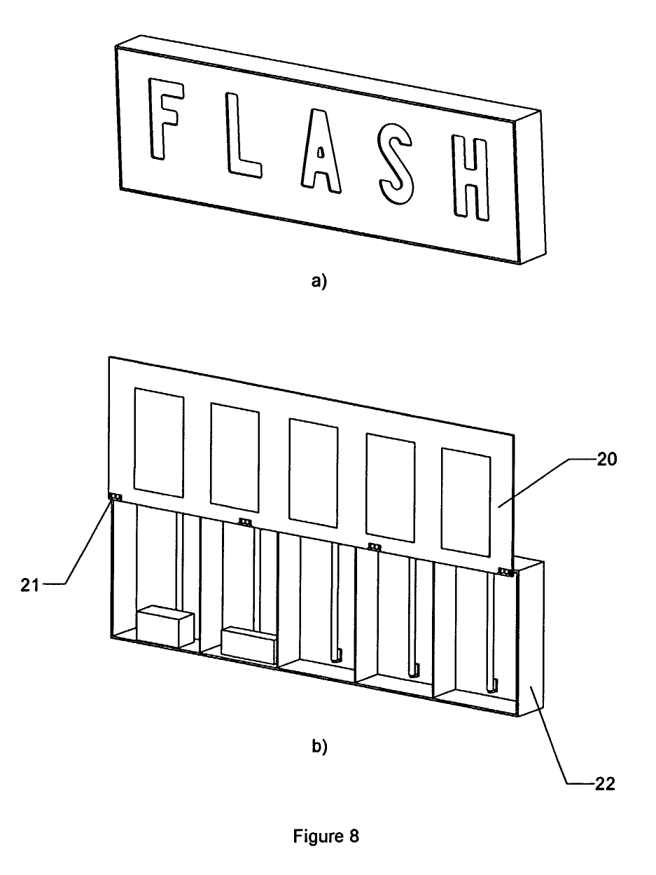

As shown in FIGS. 7 to 8, the data coming from a computer are transmitted to the programmable electronic unit (25) transmitting the pulses in sequence to the electronic relays (26), which transmitting the signal to varied neon lights (24) connected by means of ballast and mounted between each separator (23) inside the case (22) allowing to light or make flash independently each letter according a predetermined sequence varying from one to fifty second depending of the desired visual effect.

A case (22) having an opaque front part (20) including the jagged letters, which is mounted to this one by the conventional hinges (21), which allow to lift up or lower the front part (20) in order to modify if desired the program of electronic unit (25), and make easier the reparation and maintenance.

The separators (23) flush to the case (22) are mounted between each jagged letter.

Although only a single embodiment of the present invention has been described and illustrated, the present invention is not limited to the features of this embodiment, but includes all variations and modifications within the scope of claims attached hereto without departing from the spirit of the invention.

The embodiments of the invention for which an exclusive property or privilege is claimed, are defined as follows:

1. The data coming from a computer are transmitted to the programmable electronic unit, which transmitting the pulses in sequence to the electronic relays, and which transmitting the signal to varied luminous element connected by means of ballast inside a case and channel letters provided with a top according a predetermined sequence varying from one to fifty second depending of the desired visual effect.

2. The case of the claim 1 having a translucent or opaque front part includes the jagged letters allowing to said raised channels letters passing through of said front part.

3. The neon lights of the claim 1 are mounted inside said case allowing to light said case and the neon lights mounted inside of said channel letters allowing to light or making flash said channel letters provided with a rubber trim avoiding the reflection of luminous element onto said case.

4. The hinges having a fixed and sliding part are mounted to said case and to said front part, which allow to move forward or to lift up before to lower said front part to free said raised channel letters in order to modify if desired the program of said electronic unit, and make easier the reparation and maintenance.

5. The structural arm members are mounted inside said channel letters keeping said neon lights in position, and make easier the installation and maintenance of these ones.

6. The data coming from a computer are transmitted to the second programmable electronic unit, which transmitting the pulses in sequence to the second electronic relays, and which transmitting the signal to second varied luminous element connected by means of second ballast inside a second case and second channel letters according a predetermined sequence varying from one to fifty second depending of the desired visual effect.

7. The case of the claim 6 having a plain translucent front part is mounted to said said case by the conventional hinges, which allow to lift up or lower a second front part in order to modify if desired the program of said second electronic unit, and make easier the reparation and maintenance.

8. The neon lights of the claim 6 are connected inside said second case by said second ballast allowing to light this one, and said neon lights mounted inside of said second channel letters flush to said second case allow to light or making flash these ones.

9. The said structural arm members of the claim 5 are mounted inside said channel letters keeping said neon lights in position, and make easier the installation and maintenance of these ones.

10. The data coming from a computer are transmitted to the third programmable electronic unit, which transmitting the pulses in sequence to the third electronic relays, and which transmitting the signal to the third varied neon lights connected by means of ballast, and which each said neon light is mounted between the separators inside said third case allowing to light or make flash independently each letter according a predetermined sequence varying from one to fifty second depending of the desired visual effect.

11. The case of the claim 10 having a third opaque front part including the jagged letters, which is mounted to said third case by the conventional hinges, which allow to lift up or lower said third front part in order to modify if desired the program of said third electronic unit, and make easier the reparation and maintenance.

12. The separators flush to said third case are mounted between each jagged letter.

13. The electronic programming of said programmable electronic unit may be also adapted for a conventional illuminated sign already installed.
